(19) United States
(12) Patent Application Publication
(10) Pub. No.: US 2025/0149049 A1
(43) Pub. Date: May 8, 2025

(54) AUDIO SIGNAL PROCESSING METHOD AND APPARATUS

(71) Applicant: HUAWEI TECHNOLOGIES CO., LTD., Shenzhen (CN)

(72) Inventors: Zhuo WANG, Shenzhen (CN); Bin FENG, Shenzhen (CN); Chunhui DU, Shenzhen (CN); Fan FAN, Shenzhen (CN)

(21) Appl. No.: 19/013,976

(22) Filed: Jan. 8, 2025

Related U.S. Application Data
(63) Continuation of application No. PCT/CN2023/092045, filed on May 4, 2023.

(30) Foreign Application Priority Data
Jul. 27, 2022 (CN) 202210892836.1
Sep. 19, 2022 (CN) 202211139722.6

(51) Int. Cl. G10L 19/032; G10L 19/008

(52) U.S. Cl. CPC G10L 19/032; G10L 19/008

(57) ABSTRACT

This application discloses an audio signal processing method and apparatus, and belongs to the field of audio signal processing technologies. The method includes: obtaining a plurality of sub-bands of an audio signal and a scale factor of each sub-band; determining, based on the scale factors of the plurality of sub-bands, a reference value used for shaping a spectral envelope of the audio signal; and shaping the spectral envelope of the audio signal by using the reference value as a baseline, to obtain an adjustment factor of each sub-band corresponding to a shaped spectral envelope. The adjustment factor is used to quantize a spectral value of the audio signal, and/or the adjustment factor is used to dequantize a code value of the spectral value. In this application, compression efficiency of encoding an audio signal is improved while sound quality is ensured.

### CROSS-REFERENCE TO RELATED APPLICATIONS

This application is a continuation of International Application No. PCT/CN2023/092045, filed on May 4, 2023, which claims priority to Chinese Patent Application No. 202210892836.1, filed on Jul. 27, 2022, and Chinese Patent Application No. 202211139722.6, filed on Sep. 19, 2022. All of the aforementioned patent applications are hereby incorporated by reference in their entireties.

### TECHNICAL FIELD

This application relates to the field of audio signal processing technologies, and in particular, to an audio signal processing method and apparatus.

### BACKGROUND

As quality of life improves, people have increasing requirements on high-quality audio. To better transmit an audio signal on a limited bandwidth, data compression usually needs to be performed on the audio signal at an encoder side, and then a compressed bitstream is transmitted to a decoder side. The decoder side decodes the received bitstream, to obtain a decoded audio signal. The decoded audio signal is used for playback.

However, in a process of compressing the audio signal, sound quality of the audio signal may be affected. Therefore, how to improve compression efficiency of an audio signal while ensuring sound quality of the audio signal becomes a technical problem that urgently needs to be resolved.

### SUMMARY

This application provides an audio signal processing method and apparatus, to improve compression efficiency of encoding an audio signal while ensuring sound quality. The technical solutions are as follows.

According to a first aspect, this application provides an audio signal processing method. The method includes: obtaining a plurality of sub-bands of an audio signal and a scale factor of each sub-band; determining, based on the scale factors of the plurality of sub-bands, a reference value used for shaping a spectral envelope of the audio signal; and shaping the spectral envelope of the audio signal by using the reference value as a baseline, to obtain an adjustment factor of each sub-band corresponding to a shaped spectral envelope. The adjustment factor is used to quantize a spectral value of the audio signal, and/or the adjustment factor is used to dequantize a code value of the spectral value.

In the audio signal processing method provided in this application, after the plurality of sub-bands of the audio signal and the scale factor of each sub-band are obtained, the reference value used for shaping the spectral envelope of the audio signal may be determined based on the scale factors of the plurality of sub-bands, and the spectral envelope of the audio signal is shaped by using the reference value as the baseline, to obtain the adjustment factor of each sub-band corresponding to the shaped spectral envelope. The adjustment factor is used to quantize the spectral value of the audio signal. Therefore, in the method, when the spectral envelope of the audio signal is shaped based on the reference value, and the adjustment factor obtained through shaping is used to quantize the spectral value of the audio signal, compression efficiency of encoding the audio signal can be improved while sound quality is ensured.

In an embodiment, the shaping the spectral envelope of the audio signal by using the reference value as a baseline, to obtain an adjustment factor of each sub-band corresponding to a shaped spectral envelope includes: obtaining a difference between the scale factor of the sub-band and the reference value; and adjusting the scale factor of the sub-band based on the difference, to obtain the adjustment factor.

A sub-band with high energy has auditory masking effect on a sub-band with low energy. In other words, when adjacent sub-bands have different energy, masking effect exists between the adjacent sub-bands. When the audio signal is shaped, the scale factors of the plurality of sub-bands may be masked, to obtain better sound quality. In an embodiment, before the shaping the spectral envelope of the audio signal by using the reference value as a baseline, to obtain an adjustment factor of each sub-band corresponding to a shaped spectral envelope, the method further includes: masking the scale factor of the sub-band, and updating the scale factor of the sub-band based on a masked scale factor of the sub-band. In this case, the difference may be obtained based on the reference value and the masked scale factor of the sub-band.

In an embodiment, when the audio signal is a dual-channel signal, the adjusting the scale factor of the sub-band based on the difference, to obtain the adjustment factor includes: scaling down the difference, to obtain a scaled-down difference; updating the scale factor of the sub-band based on the scaled-down difference and the reference value; and obtaining the adjustment factor based on an updated scale factor of the sub-band.

A scale-down multiple of the difference is determined based on a value of the difference. When a strength of the audio signal is greater than the reference value, the human ear is more sensitive to the audio signal. When the strength of the audio signal is less than or equal to the reference value, the human ear is less sensitive to the audio signal. In this case, when the difference indicates that the scale factor of the sub-band is greater than the reference value, the scale-down multiple of the difference may be less than a scale-down multiple obtained when the difference indicates that the scale factor of the sub-band is less than or equal to the reference value.

In an embodiment, when the audio signal is a mono-channel signal, the scale factor of the sub-band may be adjusted according to a principle in which a larger scale factor is scaled up and a smaller scale factor is removed, and the adjusting the scale factor of the sub-band based on the difference, to obtain the adjustment factor includes: determining the difference as the adjustment factor.

In an embodiment, before the obtaining a difference between the scale factor of the sub-band and the reference value, the method further includes: performing signal enhancement on the scale factor of the sub-band, and updating the scale factor of the sub-band based on a scale factor that is of the sub-band and on which signal enhancement has been performed. In this case, the difference is obtained based on the reference value and the scale factor that is of the sub-band and on which signal enhancement has been performed.

In an embodiment, when the audio signal is a dual-channel signal, the reference value is obtained based on an average value of the scale factors of the plurality of sub-bands; and when the audio signal is a mono-channel signal, the reference value is obtained based on a maximum value in the scale factors of the plurality of sub-bands.

In an embodiment, before the determining, based on the scale factors of the plurality of sub-bands, a reference value used for shaping a spectral envelope of the audio signal, the method further includes: masking the scale factor of the sub-band, and updating the scale factor of the sub-band based on the masked scale factor of the sub-band. In this case, the reference value is obtained based on masked scale factors of the plurality of sub-bands.

In an embodiment, when the audio signal is a mono-channel signal, before the determining, based on the scale factors of the plurality of sub-bands, a reference value used for shaping a spectral envelope of the audio signal, the method further includes: performing signal enhancement on the scale factor of the sub-band, and updating the scale factor of the sub-band based on a scale factor that is of the sub-band and on which signal enhancement has been performed.

In an embodiment, a strength of performing signal enhancement on the scale factor of the sub-band is determined based on a frequency of the sub-band and a total number of the plurality of sub-bands. In an embodiment, the strength may be determined based on a proportion of the frequency of the sub-band in a frequency of the audio signal. In an embodiment, the scale factor of the sub-band may be added based on the proportion of the frequency of the sub-band in the frequency of the audio signal, to obtain the scale factor that is of the sub-band and on which signal enhancement has been performed.

In an embodiment, the masking the scale factor of the sub-band includes: obtaining a masking coefficient that an adjacent sub-band of the sub-band has on the sub-band and a scale factor of the adjacent sub-band, where the masking coefficient indicates a masking degree; and obtaining the masked scale factor of the sub-band based on the scale factor of the sub-band, the scale factor of the adjacent sub-band, and the masking coefficient that the adjacent sub-band has on the sub-band.

In an embodiment, when the audio signal is a dual-channel signal, the masking coefficient is determined based on a value relationship between the scale factor of the sub-band and the reference value; and when the audio signal is a mono-channel signal, the masking coefficient is determined based on a frequency relationship between the sub-band and the adjacent sub-band.

The audio signal processing method provided in embodiments of this application may be performed when a specified condition is met. In other words, the shaping the spectral envelope of the audio signal by using the reference value as a baseline, to obtain an adjustment factor of each sub-band corresponding to a shaped spectral envelope includes: when a bit rate of the audio signal is less than a bit rate threshold and/or an energy concentration of the audio signal is less than a concentration threshold, shaping the spectral envelope of the audio signal by using the reference value as the baseline, to obtain the adjustment factor of each sub-band corresponding to the shaped spectral envelope.

A bit rate indicates a number of data bits transmitted per unit of time during data transmission. An audio signal transmission scenario may include a low bit rate scenario and a high bit rate scenario. The low bit rate scenario usually occurs in a case in which interference is strong, for example, in environments, for example, a subway, an airport, and a railway station, in which a signal is vulnerable to interference. The high bit rate scenario usually occurs in a case in which interference is weak, for example, in a quiet indoor environment in which signal interference is small. Spectral noise shaping is shaping, according to the human ear auditory masking principle, a quantization noise spectrum generated by a codec. Therefore, whether to shape the audio signal may be determined based on the bit rate.

The energy concentration indicates a distribution status of audio content in the audio signal. Whether the audio signal includes substantive content can be distinguished based on the energy concentration of the audio signal. When the audio signal includes substantive content, the audio signal may be shaped, to improve sound quality of the audio signal transmitted to an audio receiving device. When the audio signal does not include substantive content, the audio signal does not need to be shaped.

According to a second aspect, this application provides an audio signal processing apparatus. The apparatus includes: an obtaining module, configured to obtain a plurality of sub-bands of an audio signal and a scale factor of each sub-band; a determining module, configured to determine, based on the scale factors of the plurality of sub-bands, a reference value used for shaping a spectral envelope of the audio signal; and a processing module, configured to shape the spectral envelope of the audio signal by using the reference value as a baseline, to obtain an adjustment factor of each sub-band corresponding to a shaped spectral envelope. The adjustment factor is used to quantize a spectral value of the audio signal, and/or the adjustment factor is used to dequantize a code value of the spectral value.

In an embodiment, the processing module is configured to: obtain a difference between the scale factor of the sub-band and the reference value; and adjust the scale factor of the sub-band based on the difference, to obtain the adjustment factor.

In an embodiment, the processing module is further configured to mask the scale factor of the sub-band, and update the scale factor of the sub-band based on a masked scale factor of the sub-band.

In an embodiment, when the audio signal is a dual-channel signal, the processing module is configured to: scale down the difference, to obtain a scaled-down difference; update the scale factor of the sub-band based on the scaled-down difference and the reference value; and obtain the adjustment factor based on an updated scale factor of the sub-band.

In an embodiment, a scale-down multiple of the difference is determined based on a value of the difference.

In an embodiment, when the audio signal is a mono-channel signal, the processing module is configured to determine the difference as the adjustment factor.

In an embodiment, the processing module is further configured to perform signal enhancement on the scale factor of the sub-band, and update the scale factor of the sub-band based on a scale factor that is of the sub-band and on which signal enhancement has been performed.

In an embodiment, when the audio signal is a dual-channel signal, the reference value is obtained based on an average value of the scale factors of the plurality of sub-bands; and when the audio signal is a mono-channel signal, the reference value is obtained based on a maximum value in the scale factors of the plurality of sub-bands.

In an embodiment, the processing module is further configured to mask the scale factor of the sub-band, and update the scale factor of the sub-band based on the masked scale factor of the sub-band.

In an embodiment, when the audio signal is a mono-channel signal, the processing module is further configured to perform signal enhancement on the scale factor of the sub-band, and update the scale factor of the sub-band based on a scale factor that is of the sub-band and on which signal enhancement has been performed.

In an embodiment, a strength of performing signal enhancement on the scale factor of the sub-band is determined based on a frequency of the sub-band and a total number of the plurality of sub-bands.

In an embodiment, the processing module is configured to: obtain a masking coefficient that an adjacent sub-band of the sub-band has on the sub-band and a scale factor of the adjacent sub-band, where the masking coefficient indicates a masking degree; and obtain the masked scale factor of the sub-band based on the scale factor of the sub-band, the scale factor of the adjacent sub-band, and the masking coefficient that the adjacent sub-band has on the sub-band.

In an embodiment, when the audio signal is a dual-channel signal, the masking coefficient is determined based on a value relationship between the scale factor of the sub-band and the reference value; and when the audio signal is a mono-channel signal, the masking coefficient is determined based on a frequency relationship between the sub-band and the adjacent sub-band.

In an embodiment, the processing module is configured to: when a bit rate of the audio signal is less than a bit rate threshold and/or an energy concentration of the audio signal is less than a concentration threshold, shape the spectral envelope of the audio signal by using the reference value as the baseline, to obtain the adjustment factor of each sub-band corresponding to the shaped spectral envelope.

According to a third aspect, this application provides a computer device, including a memory and a processor. The memory stores program instructions, and the processor runs the program instructions to perform the method provided in the first aspect and any one of the possible implementations of the first aspect in this application.

According to a fourth aspect, this application provides a computer-readable storage medium. The computer-readable storage medium is a non-volatile computer-readable storage medium, and the computer-readable storage medium includes program instructions. When the program instructions are run on a computer device, the computer device is enabled to perform the method provided in the first aspect and any one of the possible implementations of the first aspect in this application.

According to a fifth aspect, this application provides a computer program product including instructions. When the computer program product runs on a computer, the computer is enabled to perform the method provided in the first aspect and any one of the possible implementations of the first aspect in this application.

### BRIEF DESCRIPTION OF DRAWINGS

FIG. 1 is a diagram of a short-range transmission scenario according to an embodiment of this application;

FIG. 2 is a diagram of a system architecture related to an audio signal processing method according to an embodiment of this application;

FIG. 3A and FIG. 3B are a diagram of an audio encoding/decoding overall framework according to an embodiment of this application;

FIG. 4 is a diagram of a structure of a computer device according to an embodiment of this application;

FIG. 5 is a flowchart of an audio signal processing method according to an embodiment of this application;

FIG. 6 is a flowchart of masking a scale factor of a sub-band according to an embodiment of this application;

FIG. 7 is a flowchart of shaping a spectral envelope of an audio signal by using a reference value as a baseline to obtain an adjustment factor of each sub-band corresponding to a shaped spectral envelope according to an embodiment of this application;

FIG. 8 is a flowchart of adjusting a scale factor of a sub-band based on a difference to obtain an adjustment factor according to an embodiment of this application; and

FIG. 9 is a diagram of a structure of an audio signal processing apparatus according to an embodiment of this application.

### DESCRIPTION OF EMBODIMENTS

To make objectives, technical solutions, and advantages of this application clearer, the following further describes the implementations of this application in detail with reference to accompanying drawings.

First, an implementation environment and background knowledge related to embodiments of this application are described.

As short-range transmission devices (for example, a Bluetooth device) like true wireless stereo (TWS) headsets, smart speakers, and smart watches are widely popularized and used in people's daily life, people's requirements for high-quality audio playing experience in various scenarios become increasingly urgent, especially in environments where Bluetooth signals are vulnerable to interference, for example, subways, airports, and railway stations. In a short-range transmission scenario, due to a limit of a channel connecting an audio sending device and an audio receiving device on a data transmission size, during audio signal transmission, to reduce a bandwidth occupied during audio signal transmission, an audio encoder in the audio sending device is usually configured to encode the audio signal, and then an encoded audio signal is transmitted to the audio receiving device. After receiving the encoded audio signal, the audio receiving device needs to decode the encoded audio signal by using an audio decoder in the audio receiving device, and then plays a decoded audio signal. It can be learned that, while the short-range transmission devices are popularized, various audio codecs are also promoted to flourish. The short-range transmission scenario may include a Bluetooth transmission scenario, a wireless transmission scenario, and the like. In embodiments of this application, a Bluetooth transmission scenario is used as an example to describe an audio signal processing method provided in embodiments of this application.

Currently, Bluetooth audio codecs include a sub-band encoder (SBC), a Bluetooth advanced audio encoder (AAC) series (for example, AAC-LC, AAC-LD, AAC-HE, and AAC-HEv2) of the moving picture experts group (MPEG), an LDAC, an aptX series (for example, aptX, aptX HD, and aptX low-latency) encoder, a low-latency high-definition audio codec (LHDC), a low-energy low-latency LC3 audio codec, an LC3plus, and the like.

However, encoding causes a loss of a high-frequency component of an audio signal, and sound quality is reduced. Consequently, an auditory sense of a decoded audio signal obtained is poor. Especially in a scenario in which a bit rate is low, the audio codec reduces a bandwidth to reduce the bit rate. Consequently, a large number of high-frequency components of the audio signal are lost. Therefore, to improve sound quality, the audio sending device may process the audio signal, encode a processed audio signal, and then send an encoded audio signal to the audio receiving device. For example, to improve subjective auditory quality of the decoded audio signal, the audio sending device may perform spectral noise shaping on the audio signal, and then send, to the audio receiving device, an audio signal on which spectral noise shaping and encoding are performed. Spectral noise shaping is a technology of shaping, according to a human ear auditory masking principle, a quantization noise spectrum generated by a codec. In other words, the noise spectrum of a signal is adjusted to a shape similar to a speech spectrum, so that noise in the signal is not easily perceived based on human ear auditory masking effect.

In view of this, embodiments of this application provide an audio signal processing method. The audio signal processing method may be considered as a spectral noise shaping method. The method includes: obtaining a plurality of sub-bands of an audio signal and a scale factor of each sub-band; determining, based on the scale factors of the plurality of sub-bands, a reference value used for shaping a spectral envelope of the audio signal; and shaping the spectral envelope of the audio signal by using the reference value as a baseline, to obtain an adjustment factor of each sub-band corresponding to a shaped spectral envelope. The adjustment factor is used to quantize a spectral value of the audio signal, and/or the adjustment factor is used to dequantize a code value of the spectral value. The audio signal may be a signal presented in an audio form, for example, a speech signal or a music signal.

When the spectral envelope of the audio signal is shaped based on the reference value to obtain the adjustment factor, and the adjustment factor is used to quantize the spectral value of the audio signal, and/or dequantize the code value of the spectral value, compression efficiency of encoding the audio signal can be improved while sound quality is ensured.

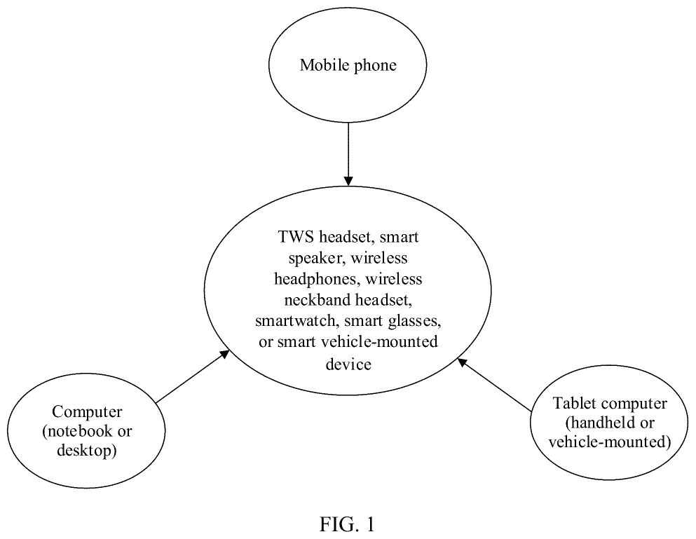

FIG. 1 is a diagram of an application scenario related to an audio signal processing method according to an embodiment of this application. Refer to FIG. 1. The application scenario includes an audio sending device and an audio receiving device. An audio encoder is configured for the audio sending device. An audio decoder is configured for the audio receiving device. In an embodiment, the audio sending device may be a device that can send an audio data stream, for example, a mobile phone, a computer (for example, a notebook computer or a desktop computer), a tablet (for example, a handheld tablet or a vehicle-mounted tablet), an intelligent wearable device, and the like. The audio receiving device may be a device that can receive and play the audio data stream, for example, a headset (for example, a TWS headset, a wireless headphone, or a wireless neckband headset), a speaker (for example, a smart speaker), an intelligent wearable device (for example, a smartwatch or smart glasses), a smart vehicle-mounted device, and the like. In some scenarios, the audio receiving device in a short-range transmission scenario may alternatively be a mobile phone, a computer, a tablet, or the like.

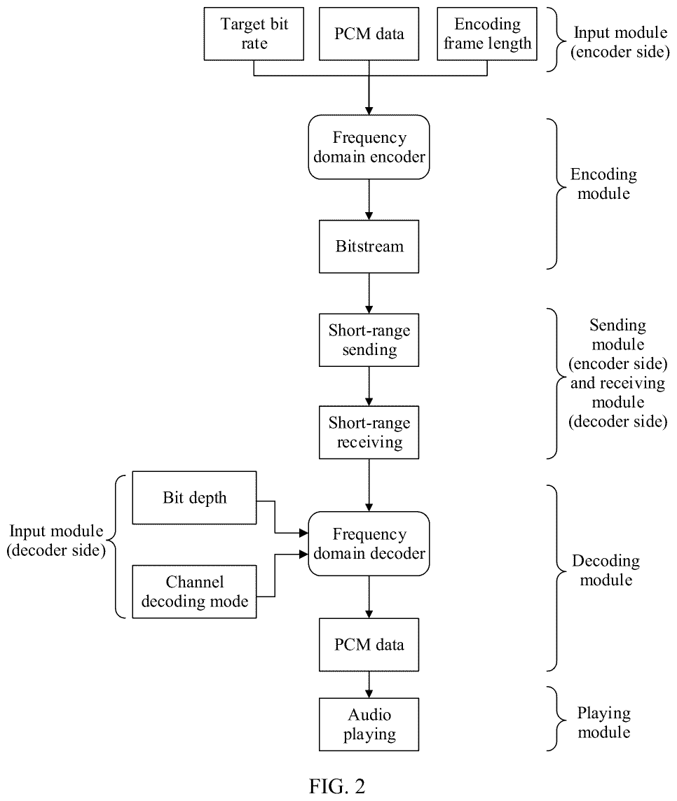

FIG. 2 is a diagram of a system architecture related to an audio signal processing method according to an embodiment of this application. Refer to FIG. 2. The system includes an encoder side and a decoder side. The encoder side includes an input module, an encoding module, and a sending module. The decoder side includes a receiving module, an input module, a decoding module, and a playing module.

At the encoder side, a user determines one encoding mode from two encoding modes based on a usage scenario, where the two encoding modes are a low-latency encoding mode and a high-sound-quality encoding mode. Encoding frame lengths of the two encoding modes are 5 ms and 10 ms respectively. For example, if the use scenario is playing a game, live broadcasting, or making a call, the user may select the low-latency encoding mode; or if the use scenario is enjoying music, or the like through a headset or a speaker, the user may select the high-sound-quality encoding mode. The user further needs to provide a to-be-encoded audio signal (pulse code modulation (PCM) data shown in FIG. 2) to the encoder side. In addition, the user further needs to set a target bit rate of a bitstream obtained through encoding, namely, an encoding bit rate of the audio signal. A higher target bit rate indicates better sound quality, but poorer anti-interference performance of a bitstream in a short-range transmission process. A lower target bit rate indicates poorer sound quality, but better anti-interference performance of a bitstream in a short-range transmission process. In brief, the input module at the encoder side obtains the encoding frame length, the encoding bit rate, and the to-be-encoded audio signal that are submitted by the user.

The input module at the encoder side inputs data submitted by the user into a frequency domain encoder of the encoding module.

The frequency domain encoder of the encoding module performs encoding based on the received data, to obtain a bitstream. A frequency domain encoder side analyzes the to-be-encoded audio signal, to obtain signal characteristics (including a mono/dual-channel signal, a stable/non-stable signal, a full-bandwidth/narrow-bandwidth signal, a subjective/objective signal, and the like). The audio signal enters a corresponding encoding processing submodule based on the signal characteristics and a bit rate level (namely, the encoding bit rate). The encoding processing submodule encodes the audio signal, and packages a packet header (including a sampling rate, a channel number, an encoding mode, a frame length, and the like) of the bitstream, to finally obtain the bitstream.

The sending module at the encoder side sends the bitstream to the decoder side. In an embodiment, the sending module is the sending module shown in FIG. 2 or another type of sending module. This is not limited in embodiments of this application.

At the decoder side, after receiving the bitstream, the receiving module at the decoder side sends the bitstream to a frequency domain decoder of the decoding module, and notifies the input module at the decoder side to obtain a configured bit depth, a configured channel decoding mode, or the like. In an embodiment, the receiving module is the receiving module shown in FIG. 2 or another type of receiving module. This is not limited in embodiments of this application.

The input module at the decoder side inputs obtained information such as the bit depth and the sound channel decoding mode into the frequency domain decoder of the decoding module.

The frequency domain decoder of the decoding module decodes the bitstream based on the bit depth, the channel decoding mode, and the like, to obtain required audio data (the PCM data shown in FIG. 2), and sends the obtained audio data to the playing module. The playing module plays audio. The sound channel decoding mode indicates a channel that needs to be decoded.

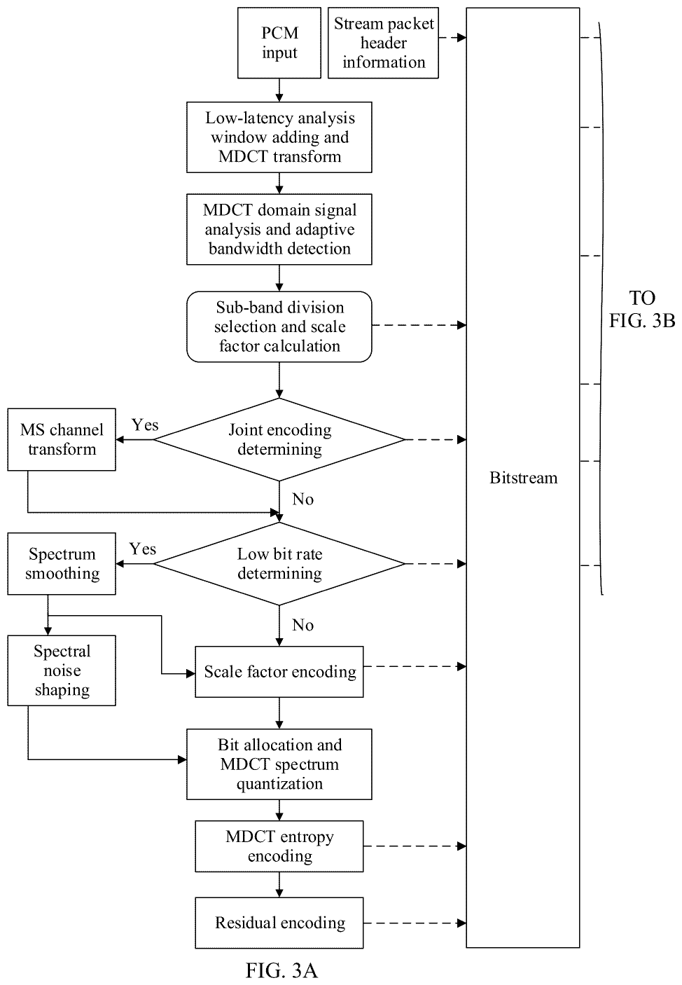

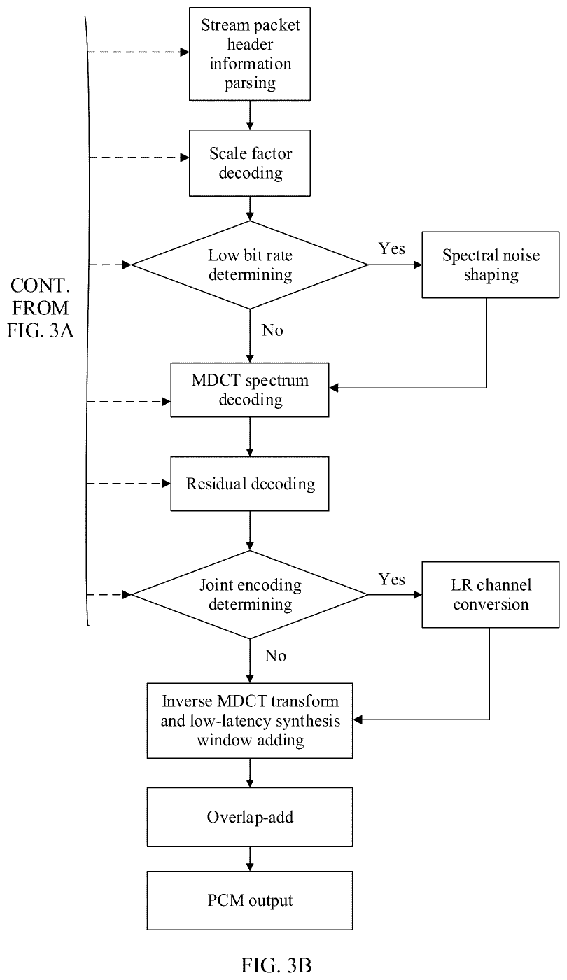

FIG. 3A and FIG. 3B are a diagram of an audio encoding/decoding overall framework according to an embodiment of this application. Refer to FIG. 3A and FIG. 3B. An encoding procedure at an encoder side includes the following operations.
(1) PCM input module

PCM data is input. The PCM data is mono-channel data or dual-channel data, and a bit depth may be 16 bits, 24 bits, a 32-bit floating point number, or a 32-bit fixed point number. In an embodiment, the PCM input module converts the input PCM data to a same bit depth, for example, a bit depth of 24 bits, performs deinterleaving on the PCM data, and then places the deinterleaved PCM data on a left channel and a right channel.
(2) Low-latency analysis window adding module and modified discrete cosine transform (MDCT) transform module

A low-latency analysis window is added to and MDCT transform is performed on the processed PCM data obtained in operation (1), to obtain spectrum data in an MDCT domain. The window is added to prevent spectrum leakage.
(3) MDCT domain signal analysis module and adaptive bandwidth detection module

The MDCT domain signal analysis module takes effect in a full bit rate scenario, and the adaptive bandwidth detection module is activated at a low bit rate (for example, a bit rate≤150 kbps/channel). First, bandwidth detection is performed on the spectrum data in the MDCT domain obtained in operation (2), to obtain a cut-off frequency or an effective bandwidth. Then, signal analysis is performed on spectrum data within the effective bandwidth, that is, whether frequency distribution is centralized or even is analyzed, to obtain an energy concentration, and a flag indicating whether the to-be-encoded audio signal is an objective signal or a subjective signal (the flag of the objective signal is 1, and the flag of the subjective signal is 0) is obtained based on the energy concentration. If the audio signal is the objective signal, spectral noise shaping (SNS) and MDCT spectrum smoothing are not performed on a scale factor at a low bit rate, because this reduces encoding effect of the objective signal. Then, whether to perform a sub-band cut-off operation in the MDCT domain is determined based on a bandwidth detection result and the flag of the subjective signal and the flag of the objective signal. If the audio signal is the objective signal, the sub-band cut-off operation is not performed; or if the audio signal is the subjective signal and the bandwidth detection result is identified as 0 (in a full bandwidth), the sub-band cut-off operation is determined based on a bit rate; or if the audio signal is the subjective signal and the bandwidth detection result is not identified as 0 (that is, a bandwidth is less than half of a limited bandwidth of a sampling rate), the sub-band cut-off operation is determined based on the bandwidth detection result.
(4) Sub-band division selection and scale factor calculation module

Based on a bit rate level, and the flag of the subjective signal and the flag of objective signal and the cut-off frequency that are obtained in operation (3), an optimal sub-band division manner is selected from a plurality of sub-band division manners, and a total number of sub-bands for encoding the audio signal is obtained. In addition, an envelope of a spectrum is obtained through calculation, that is, a scale factor corresponding to the selected sub-band division manner is calculated.
(5) MS channel transform module

For the dual-channel PCM data, joint encoding determining is performed based on the scale factor calculated in operation (4), that is, whether to perform MS channel transform on the left-channel data and the right-channel data is determined.
(6) Spectrum smoothing module and scale factor-based spectral noise shaping module

The spectrum smoothing module performs MDCT spectrum smoothing based on a setting of the low bit rate (for example, the bit rate≤150 kbps/channel), and the spectral noise shaping module performs, based on the scale factor, spectral noise shaping on data on which spectrum smoothing is performed, to obtain an adjustment factor, where the adjustment factor is used to quantize a spectral value of the audio signal. The setting of the low bit rate is controlled by a low bit rate determining module. When the setting of the low bit rate is not met, spectrum smoothing and spectral noise shaping do not need to be performed.
(7) Scale factor encoding module

Differential encoding or entropy encoding is performed on scale factors of a plurality of sub-bands based on distribution of the scale factors.
(8) Bit allocation and MDCT spectrum quantization and entropy encoding module

Based on the scale factor obtained in operation (4) and the adjustment factor obtained in operation (6), encoding is controlled to be in a constant bit rate (CBR) encoding mode according to a bit allocation strategy of rough estimation and precise estimation, and quantization and entropy encoding are performed on an MDCT spectral value.
(9) Residual encoding module

If bit consumption in operation (8) does not reach a target bit, importance sorting is further performed on the sub-bands, and a bit is preferably allocated to encoding of an MDCT spectral value of an important sub-band.
(10) Stream packet header information packaging module

Packet header information includes an audio sampling rate (for example, 44.1 kHz/48 kHz/88.2 kHz/96 kHz), channel information (for example, mono channel and dual channel), an encoding frame length (for example, 5 ms and 10 ms), an encoding mode (for example, a time domain mode, a frequency domain mode, a time domain-to-frequency domain mode, or a frequency domain-to-time domain mode), and the like.
(11) Bitstream sending module

The bitstream includes the packet header, side information, a payload, and the like. The packet header carries the packet header information, and the packet header information is as described in operation (10). The side information includes information such as the encoded bitstream of the scale factor, information about the selected sub-band division manner, cut-off frequency information, a low bit rate flag, joint encoding determining information (namely, an MS transform flag), and a quantization operation. The payload includes the encoded bitstream and a residual encoded bitstream of the MDCT spectrum.

A decoding procedure at a decoder side includes the following operations.
(1) Stream packet header information parsing module

The stream packet header information parsing module parses the packet header information from the received bitstream, where the packet header information includes information such as the sampling rate, the channel information, the encoding frame length, and the encoding mode of the audio signal; and obtains the encoding bit rate through calculation based on a bitstream size, the sampling rate, and the encoding frame length, that is, obtains bit rate level information.
(2) Scale factor decoding module

The scale factor decoding module decodes the side information from the bitstream. The side information includes information, such as the information about the selected sub-band division manner, the cut-off frequency information, the low bit rate flag, the joint encoding determining information, the quantization operation, and the scale factors of the sub-bands.
(3) Scale factor-based spectral noise shaping module

At the low bit rate (for example, the encoding bit rate less than 150 kbps/channel), spectral noise shaping further needs to be performed based on the scale factor, to obtain the adjustment factor. The adjustment factor is used to dequantize a code value of the spectral value. The setting of the low bit rate is controlled by the low bit rate determining module. When the setting of the low bit rate is not met, spectral noise shaping does not need to be performed.
(4) MDCT spectrum decoding module and residual decoding module

The MIDCT spectrum decoding module decodes the MDCT spectrum data in the decoded bitstream based on the information about the sub-band division manner, the quantization operation information, and the scale factors obtained in operation (2). Hole padding is performed at a low bit rate level, and if a bit obtained through calculation is still remaining, the residual decoding module performs residual decoding, to obtain MDCT spectrum data of another sub-band, so as to obtain final MDCT spectrum data.
(5) LR channel conversion module

Based on the side information obtained in operation (2), if it is determined, through joint encoding determining, that a dual-channel joint encoding mode rather than a decoding low-energy mode (for example, the encoding bit rate is greater than 150 kbps/channel and the sampling rate is greater than 88.2 kHz) is used, LR channel conversion is performed on the MDCT spectrum data obtained in operation (4).
(6) Inverse MDCT transform module, low-latency synthesis window adding module, and overlap-add module

On the basis of operation (4) and operation (5), an inverse MDCT transform module performs MDCT inverse transform on the obtained MDCT spectrum data to obtain a time-domain aliased signal. Then, the low-latency synthesis window module adds a low-latency synthesis window to the time-domain aliased signal. The overlap-add module superimposes time-domain aliased buffer signals of a current frame and a previous frame to obtain a PCM signal, that is, obtains the final PCM data based on an overlap-add method.
(7) PCM output module

The PCM output module outputs PCM data of a corresponding channel based on a configured bit depth and channel decoding mode.

It should be noted that the audio encoding/decoding framework shown in FIG. 3A and FIG. 3B is merely used as an example of a terminal in embodiments of this application, and is not intended to limit embodiments of this application. One of ordinary skilled in the art may obtain another encoding/decoding framework on the basis of FIG. 3A and FIG. 3B.

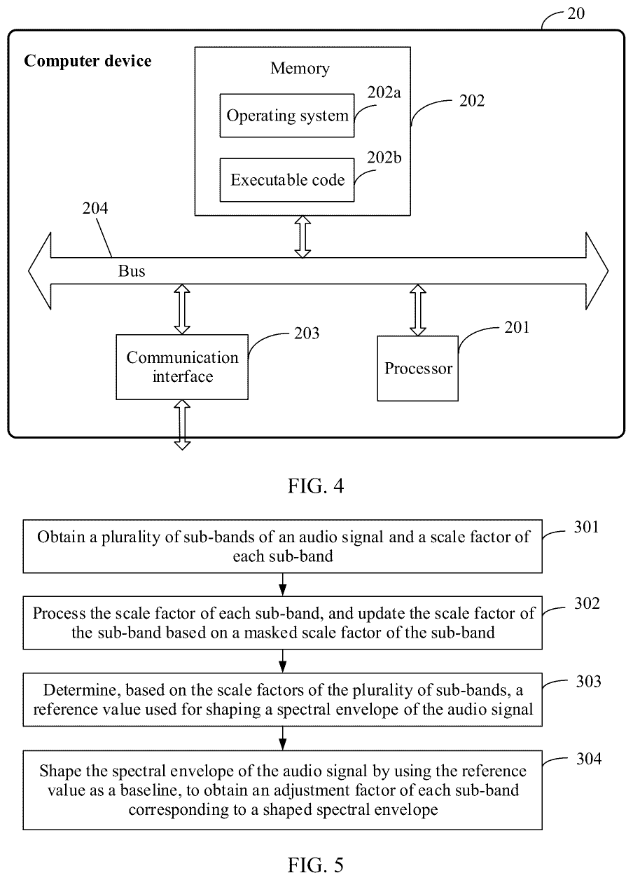

FIG. 4 is a diagram of a structure of a computer device according to an embodiment of this application. In an embodiment, the computer device may be any device shown in FIG. 1. For example, the computer device may be an audio sending device. In this case, the computer device can implement some or all functions of the audio signal processing method provided in embodiments of this application. As shown in FIG. 4, the computer device 20 includes a processor 201, a memory 202, a communication interface 203, and a bus 204. The processor 201, the memory 202, and the communication interface 203 implement communication connections with each other through the bus 204.

The computer device 20 may include a plurality of processors, for example, the processor 201 shown in FIG. 4 and a processor 205. Each of these processors is a single-core processor or a multi-core processor. In an embodiment, the processor herein is one or more devices, circuits, and/or processing cores for processing data (for example, computer program instructions). The processor 201 may include a general-purpose processor and/or a dedicated hardware chip. The general-purpose processor may include a central processing unit (CPU), a microprocessor, or a graphics processing unit (GPU). For example, the CPU is a single-core processor (single-CPU), or a multi-core processor (multi-CPU). The dedicated hardware chip is a hardware module capable of performing high-performance processing. The dedicated hardware chip includes at least one of a digital signal processor, an application-specific integrated circuit (ASIC), a field-programmable gate array (FPGA), or a network processor (NP). Alternatively, the processor 201 may be an integrated circuit chip, and has a signal processing capability. In an embodiment, some or all functions of the audio signal processing method in this application may be implemented through an integrated logic circuit of hardware in the processor 201 or instructions in a form of software.

The memory 202 is configured to store a computer program, and the computer program includes an operating system 202a and executable code (namely, program instructions) 202b. The memory 202 is, for example, a read-only memory (ROM), or another type of static storage device that can store static information and instructions, for another example, a random access memory (RAM), or another type of dynamic storage device that can store information and instructions, for another example, an electrically erasable programmable read-only memory (EEPROM), a compact disc read-only memory (CD-ROM), other optical disk storage, optical disc storage (including a compact disc, a laser disc, an optical disc, a digital versatile disc, a Blu-ray disc, or the like), a magnetic disk storage medium, another magnetic storage device, or any other medium that can be used to carry or store expected executable code in forms of instructions or in a form of a data structure and that can be accessed by a computer. However, this is not limited. For example, the memory 202 is configured to store an egress port queue, and the like. For example, the memory 202 exists independently, and is connected to the processor 201 through the bus 204. Alternatively, the memory 202 and the processor 201 are integrated together. The memory 202 may store the executable code. When the executable code stored in the memory 202 is executed by the processor 201, the processor 201 is configured to perform some or all functions of the audio signal processing method provided in embodiments of this application. In addition, for an embodiment in which the processor 201 performs a corresponding function, refer to related descriptions in method embodiments. The memory 202 may further include a software module, data, and the like that are required by another running process like the operating system.

The communication interface 203 uses a transceiver module, for example, but not limited to a transceiver, to implement communication with another device or a communication network. The communication interface 203 includes a wired communication interface, or may optionally include a wireless communication interface. The wired communication interface is, for example, an Ethernet interface. In an embodiment, the Ethernet interface is an optical interface, an electrical interface, or a combination thereof. The wireless communication interface is a wireless local area network (WLAN) interface, a cellular network communication interface, a combination thereof, or the like.

The bus 204 is any type of communication bus configured to implement interconnection between internal components (for example, the memory 202, the processor 201, and the communication interface 203) in the computer device, for example, a system bus. In embodiments of this application, an example in which the foregoing components in the computer device are interconnected through the bus 204 is used for description. In an embodiment, the foregoing components in the computer device 20 may be in communication connection to each other in a connection manner other than the bus 204. For example, the foregoing components in the computer device 20 are interconnected through an internal logical interface.

In an embodiment, the computer device further includes an output device and an input device. The output device communicates with the processor 201, and can display information in a plurality of manners. For example, the output device is a liquid crystal display (LCD), a light emitting diode (LED) display device, a cathode ray tube (CRT) display device, a projector, or the like. The input device communicates with the processor 201, and can receive an input of a user in a plurality of manners. For example, the input device is a mouse, a keyboard, a touchscreen device, or a sensing device.

It should be noted that the plurality of components may be separately disposed on chips independent of each other, or at least some or all of the components may be disposed on a same chip. Whether the components are separately disposed on different chips or integrated and disposed on one or more chips usually depends on a requirement of a product design. An embodiment form of the component is not limited in embodiments of this application. Descriptions of procedures corresponding to the foregoing accompanying drawings have respective focuses. For a part that is not described in detail in a procedure, refer to related descriptions of other procedures.

All or some of the foregoing embodiments may be implemented by using software, hardware, firmware, or any combination thereof. When software is used to implement embodiments, all or a part of the embodiments may be implemented in a form of a computer program product. The computer program product that provides a program development platform includes one or more computer instructions. When these computer program instructions are loaded and executed on the computer device, all or some of the procedures or functions of the audio signal processing method provided in embodiments of this application are implemented.

The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium stores the computer program instructions that provide the program development platform.

In an embodiment, the audio signal processing method provided in embodiments of this application may be implemented by using one or more functional modules deployed on the computer device. The one or more functional modules may be implemented by executing an executable program by the computer device. When the audio signal processing method provided in embodiments of this application is implemented by using the plurality of functional modules deployed on the computer device, the plurality of functional modules may be deployed in a central manner or in a distributed manner. In addition, the plurality of functional modules may be implemented by executing a computer program by one or more computer devices. Each of the one or more computer devices can implement some or all functions of the audio signal processing method provided in embodiments of this application.

It should be understood that the foregoing content is an example description of the application scenario of the audio signal processing method provided in embodiments of this application, and does not constitute a limitation on the application scenario of the audio signal processing method. For example, when an implementation process of the audio signal processing method is described in embodiments of this application, an example in which the audio signal processing method is applied to short-range transmission in a Bluetooth transmission scenario is used. However, it is not excluded that the audio signal processing method may be further applied to another short-range transmission scenario, for example, the audio signal processing method may be further applied to a short-range transmission scenario of wireless transmission and another scenario. The audio signal processing method provided in embodiments of this application may be applied to an audio sending device in the short-range transmission scenario, namely, an encoder side in the short-range transmission scenario, or may be applied to an encoder side in another transmission scenario, or may be applied to an audio receiving device in the short-range transmission scenario, namely, a decoder side in the short-range transmission scenario, or may be applied to a decoder side in another transmission scenario. In other words, the audio signal processing method provided in embodiments of this application may be applied to all scenarios related to coding of an audio signal. In addition, one of ordinary skilled in the art may learn that, as a service requirement changes, an application scenario may be adjusted based on an application requirement. Application scenarios are not listed one by one in embodiments of this application.

FIG. 5 is a flowchart of an audio signal processing method according to an embodiment of this application. The method may be applied to the audio sending device and the audio receiving device shown in FIG. 1. The following uses an example in which the method is applied to the audio sending device for description. As shown in FIG. 5, the method includes the following operations.

Operation 301: Obtain a plurality of sub-bands of an audio signal and a scale factor of each sub-band.

After obtaining the audio signal to be sent to the audio receiving device, the audio sending device may add a low-latency analysis window to the audio signal, transform an audio signal to which the low-latency analysis window has been added to frequency domain, to obtain a frequency domain signal of the audio signal, and then divide the frequency domain signal, to obtain the plurality of sub-bands (for example, 32 sub-bands) and obtain the scale factor (SF) of each sub-band. The scale factor of the sub-band indicates a maximum amplitude of a frequency of the sub-band. For example, the scale factor of the sub-band may indicate a number of bits required by the maximum amplitude.

The audio signal processing method provided in embodiments of this application may be performed when the following condition is met: A bit rate of the audio signal is less than a bit rate threshold, and/or an energy concentration of the audio signal is less than a concentration threshold. For example, when the bit rate of the audio signal is less than the bit rate threshold, and/or the energy concentration of the audio signal is less than the concentration threshold, operation 304 is performed. In addition, when the audio signal does not meet the condition, the audio signal processing method provided in embodiments of this application may not be performed, and an adjustment factor of each sub-band is initialized to 0.

The bit rate indicates a number of data bits transmitted per unit of time during data transmission. An audio signal transmission scenario may include a low bit rate scenario and a high bit rate scenario. The low bit rate scenario usually occurs in a case in which interference is strong, for example, in environments, for example, a subway, an airport, and a railway station, in which a signal is vulnerable to interference. The high bit rate scenario usually occurs in a case in which interference is weak, for example, in a quiet indoor environment in which signal interference is small. Spectral noise shaping is shaping, according to the human ear auditory masking principle, a quantization noise spectrum generated by a codec. Therefore, whether to shape the audio signal may be determined based on the bit rate. The bit rate threshold may be adjusted based on a requirement on sound quality or another requirement. For example, the bit rate threshold may be 150 kilobits per second (kbps). When the bit rate is less than the bit rate threshold, the bit rate for transmitting the audio signal is a low bit rate. When the bit rate is greater than or equal to the bit rate threshold, the bit rate for transmitting the audio signal is a high bit rate.

The energy concentration indicates a distribution status of audio content in the audio signal. Whether the audio signal includes substantive content can be distinguished based on the energy concentration of the audio signal. When the audio signal includes substantive content, the audio signal may be shaped, to improve sound quality of the audio signal transmitted to the audio receiving device. When the audio signal does not include substantive content, the audio signal does not need to be shaped. An audio signal that includes substantive content may be referred to as a subjective signal, and an audio signal that does not include substantive content may be referred to as an objective signal. The concentration threshold may be adjusted based on a requirement on sound quality or another requirement. For example, the concentration threshold may be 0.6. When the energy concentration is less than the concentration threshold, the audio signal is a subjective signal; and when the energy concentration is greater than or equal to the concentration threshold, the audio signal is an objective signal.

Operation 302: Process the scale factor of each sub-band, and update the scale factor of the sub-band based on a masked scale factor of the sub-band.

In an embodiment, a process of processing the scale factor includes one or more of the following: masking the scale factors of the plurality of sub-bands, and performing signal enhancement on the scale factors of the plurality of sub-bands.

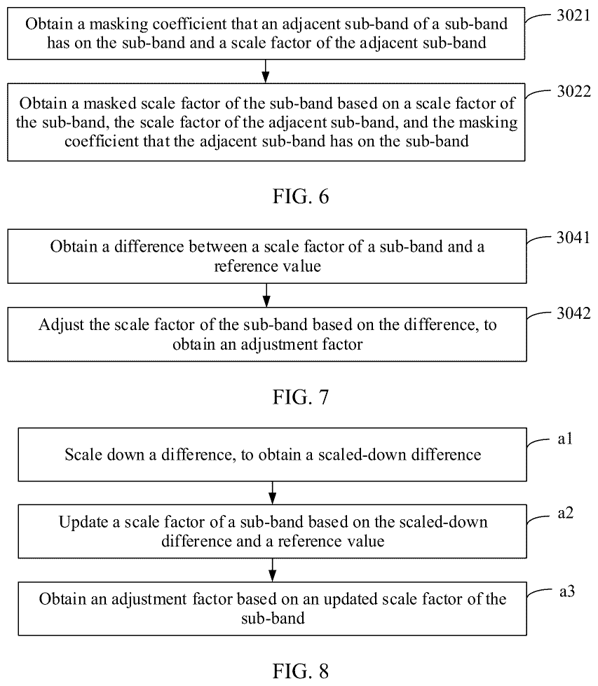

A sub-band with high energy has auditory masking effect on a sub-band with low energy. In other words, when adjacent sub-bands have different energy, masking effect exists between the adjacent sub-bands. When the audio signal is shaped, the scale factors of the plurality of sub-bands may be masked, to obtain better sound quality. In an embodiment, as shown in FIG. 6, for any one of the plurality of sub-bands, a process of masking the scale factor of the sub-band includes the following operations.

Operation 3021: Obtain a masking coefficient that an adjacent sub-band of the sub-band has on the sub-band and a scale factor of the adjacent sub-band.

Each sub-band has an index value. An index value of a sub-band adjacent to a current sub-band may be determined based on an index value of the current sub-band, and then the adjacent sub-band of the current sub-band is determined. Then, the scale factor of the adjacent sub-band may be obtained based on the scale factors of the plurality of sub-bands that are obtained in operation 301.

A masking degree that the adjacent sub-band has on the current sub-band varies with the audio signal that is a dual-channel signal or a mono-channel signal. The following separately provides descriptions thereof.

When the audio signal is a dual-channel signal, the masking degree may be determined based on a value relationship between the scale factor of the sub-band and a reference value used for shaping a spectral envelope of the audio signal. Usually, because the reference value is obtained based on the scale factors of the plurality of sub-bands and is a reference value for shaping, when the audio signal is a dual-channel signal, a masking degree obtained when the scale factor of the sub-band is greater than the reference value is usually greater than a masking degree obtained when the scale factor of the sub-band is less than or equal to the reference value. For example, when the scale factor of the sub-band is greater than the reference value, the masking coefficient may be 0.375. When the scale factor of the sub-band is less than or equal to the reference value, the masking coefficient may be 0.25. The masking coefficient indicates the masking degree.

When the audio signal is a mono-channel signal, the masking degree may be determined based on a frequency relationship between the sub-band and the adjacent sub-band. Usually, when the audio signal is a mono signal, a masking degree that the adjacent sub-band whose frequency is greater than a frequency of the sub-band has on the sub-band is less than a masking degree that the adjacent sub-band whose frequency is less than the frequency of the sub-band has on the sub-band. For example, a masking coefficient that the adjacent sub-band whose frequency is greater than the frequency of the sub-band has on the sub-band may be 0.125, and a masking coefficient that the adjacent sub-band whose frequency is less than the frequency of the sub-band has on the sub-band may be 0.175.

Operation 3022: Obtain the masked scale factor of the sub-band based on the scale factor of the sub-band, the scale factor of the adjacent sub-band, and the masking coefficient that the adjacent sub-band has on the sub-band.

The masked scale factor of the sub-band (namely, the current sub-band) may be obtained based on a difference value, weighted with the masking degree, between the scale factor of the adjacent sub-band and the scale factor of the current sub-band. In an embodiment, an implementation process of operation 3022 may include: obtaining a difference value between the scale factor of the adjacent sub-band and the scale factor of the current sub-band, and weighting the difference value with the masking coefficient that the adjacent sub-band has on the current sub-band. For example, a weight of the adjacent sub-band for the current sub-band may be added to the scale factor of the current sub-band, to obtain the masked scale factor of the current sub-band. In addition, the scale factor of the adjacent sub-band may be greater than or less than the scale factor of the current sub-band, and the difference value between the scale factor of the adjacent sub-band and the scale factor of the current sub-band may be greater than 0 or less than 0. However, when the difference value is weighted with the masking coefficient, a larger value in the difference value and 0 may be weighted with the masking coefficient, to ensure masking effect.

For example, when the audio signal is a dual-channel signal, a scale factor E(b) of a b^{th} sub-band, scale factors: E(b−1) and E(b+1) of adjacent sub-bands, and a masked scale factor E_{new} (b) of the current sub-band may meet the following formulas:

$$\begin{matrix}{E}_{new} ( b ) = E ( b ) + c \times MAX ( E ( b - 1 ) - E ( b ) , 0 ) + c \times MAX ( E ( b + 1 ) - E ( b ) , 0 ) ; \\ {E}_{new} ( 0 ) = E ( 0 ) = E ( 0 ) + c \times MAX ( E ( 1 ) - E ( 0 ) , 0 ) ; and \\ {E}_{new} ( B - 1 ) = E ( B - 1 ) + c \times MAX ( E ( B - 2 ) - E ( B - 1 ) , 0 ) ,\end{matrix}$$

where c is a masking coefficient that the adjacent sub-band has on the b^{th} sub-band, and for a value of c, reference may be made to related descriptions in operation 3021; b+1 indicates a sub-band whose frequency is greater than the frequency of the current sub-band in the adjacent sub-bands, and b−1 indicates a sub-band whose frequency is less than the frequency of the current sub-band in the adjacent sub-bands; B is a total number of sub-bands of the audio signal, and values of b, b−1, and b+1 are integers in [0, B−1]; and in an embodiment, the B sub-bands may be sub-bands that need to be encoded in the sub-bands of the audio signal, for example, sub-bands that need to be encoded and that are obtained based on a cut-off frequency of the audio signal.

When the audio signal is a mono-channel signal, a scale factor E(b) of a b^{th} sub-band, scale factors: E(b−1) and E(b+1) of adjacent sub-bands, and a masked scale factor E_{new} (b) of the current sub-band may meet the following formulas:

$$\begin{matrix}{E}_{new} ( b ) = E ( b ) + c 1 \times MAX ( E ( b - 1 ) - E ( b ) , 0 ) + c 2 \times MAX ( E ( b + 1 ) - E ( b ) , 0 ) ; \\ {E}_{new} ( 0 ) = E ( 0 ) + c 2 \times MAX ( E ( 1 ) - E ( 0 ) , 0 ) ; and \\ {E}_{new} ( B - 1 ) = E ( B - 1 ) + c 1 \times MAX ( E ( B - 2 ) - E ( B - 1 ) , 0 ) ,\end{matrix}$$

where
b+1 indicates a sub-band whose frequency is greater than the frequency of the current sub-band in the adjacent sub-bands, and b−1 indicates a sub-band whose frequency is less than the frequency of the current sub-band in the adjacent sub-bands; cl is a masking coefficient that a (b−1) th sub-band has on the b^{th} sub-band, c2 is a masking coefficient that a (b+1) th sub-band has on the b^{th} sub-band, and for values of c1 and c2, reference may be made to related descriptions in operation 3021; B is a total number of sub-bands of the audio signal, and values of b, b−1, and b+1 are integers in [0, B−1]; and in an embodiment, the B sub-bands may be sub-bands that need to be encoded in the sub-bands of the audio signal, for example, sub-bands that need to be encoded and that are obtained based on the cut-off frequency of the audio signal.

When the audio signal is a mono-channel signal, signal enhancement may be performed on the scale factors of the plurality of sub-bands, to obtain scale factors that are of the plurality of sub-bands and on which signal enhancement has been performed. In addition, when masking and signal enhancement need to be performed on the scale factor of the sub-band, the scale factor of the sub-band may be masked, and then signal enhancement is performed on a masked scale factor of the sub-band. In an embodiment, a strength of performing signal enhancement on the scale factor of the sub-band is determined based on a frequency of the sub-band and a total number of the plurality of sub-bands. In an embodiment, the strength may be determined based on a proportion of the frequency of the sub-band in a frequency of the audio signal. In an embodiment, the scale factor of the sub-band may be added based on the proportion of the frequency of the sub-band in the frequency of the audio signal, to obtain the scale factor that is of the sub-band and on which signal enhancement has been performed.

For example, the scale factor E(b) of the b^{th} sub-band and a scale factor E_{inc}(b) that is of the sub-band and on which signal enhancement has been performed may meet the following formula:

$${E}_{inc} ( b ) = E ( b ) + 3 b / ( B - 1 ) ,$$

where
B is the total number of sub-bands of the audio signal, and values of b, b-1, and b+1 are integers in [0, B-1].

Operation 303: Determine, based on the scale factors of the plurality of sub-bands, the reference value used for shaping the spectral envelope of the audio signal.

An implementation of obtaining the reference value varies with the audio signal that is a dual-channel signal or a mono-channel signal. The following separately provides descriptions thereof.

When the audio signal is a dual-channel signal, the reference value is obtained based on an average value of the scale factors of the plurality of sub-bands. For example, the reference value E_{avg} and the scale factors E(i) of the plurality of sub-bands may meet the following formula:

$${E}_{avg} = \frac{1}{B} \times {\sum }_{i = 0}^{B - 1} E ( i ) + 1 ,$$

where
B is the total number of sub-bands of the audio signal, and a value of i is an integer in [0, B−1].

In an embodiment, when the scale factors of the plurality of sub-bands are masked, the reference value may be obtained based on masked scale factors of the plurality of sub-bands. For example, when the reference value is obtained based on the average value of the scale factors of the plurality of sub-bands, scale factors used to calculate the average value may be the masked scale factors.

When the audio signal is a mono-channel signal, the reference value is obtained based on a maximum value in the scale factors of the plurality of sub-bands. In an embodiment, when the scale factors of the plurality of sub-bands are masked, the reference value may be obtained based on the masked scale factors of the plurality of sub-bands. For example, when the reference value is obtained based on the maximum value in the scale factors of the plurality of sub-bands, the maximum value is a maximum value in the masked scale factors of the plurality of sub-bands. In an embodiment, when signal enhancement is performed on the scale factors of the plurality of sub-bands, the reference value may be obtained based on scale factors that is of the plurality of sub-bands and on which signal enhancement has been performed. For example, when the reference value is obtained based on the maximum value in the scale factors of the plurality of sub-bands, the maximum value is a maximum value in the scale factors that is of the plurality of sub-bands and on which signal enhancement has been performed.

Operation 304: Shape the spectral envelope of the audio signal by using the reference value as a baseline, to obtain an adjustment factor of each sub-band corresponding to a shaped spectral envelope.

When the audio signal processing method provided in embodiments of this application is applied to the audio sending device, the audio sending device may quantize a spectral value of the audio signal based on the adjustment factor. When the audio signal processing method provided in embodiments of this application is applied to the audio receiving device, the audio receiving device may dequantize a code value of the spectral value based on the adjustment factor.

In an embodiment, the spectral envelope of the audio signal may be shaped based on the scale factor of the sub-band and the reference value used for shaping the spectral envelope of the audio signal. As shown in FIG. 7, an implementation process of operation 304 may include the following operations.

Operation 3041: Obtain a difference between the scale factor of the sub-band and the reference value.

The difference between the scale factor of the sub-band and the reference value may be represented by a difference value between the scale factor of the sub-band and the reference value. In addition, when the scale factor of the sub-band is masked, the difference may be obtained based on the reference value and the masked scale factor of the sub-band. When the audio signal is a mono-channel signal, if signal enhancement is performed on the scale factor of the sub-band, the difference may be obtained based on the reference value and the scale factor that is of the sub-band and on which signal enhancement has been performed. When the audio signal is a mono-channel signal, if masking and signal enhancement are performed on the scale factor of the sub-band, the difference may be obtained based on the reference value and the scale factor that is of the sub-band and on which masking and signal enhancement are performed.

Operation 3042: Adjust the scale factor of the sub-band based on the difference, to obtain the adjustment factor.

An implementation of adjusting the adjustment factor based on the difference varies with the audio signal that is a dual-channel signal or a mono-channel signal. The following separately provides descriptions thereof.

When the audio signal is a mono-channel signal, the scale factor of the sub-band may be adjusted according to a principle in which a larger scale factor is scaled up and a smaller scale factor is removed. In this case, an implementation process of operation 3042 includes: determining the difference as the adjustment factor. In an embodiment, when the reference value is obtained based on the maximum value in the scale factors of the plurality of sub-bands, a scale factor E_{inc}(b) that is of the b^{th} sub-band and on which signal masking and signal enhancement are performed, the maximum value Eₘₐₓ in the scale factors of the plurality of sub-bands, and an adjustment factor dr_{adjust}(b) of the b^{th} sub-band meet the following formula:

$${dr}_{adjust} ( b ) = {E}_{inc} ( b ) - {E}_{max}$$

It can be learned from a process of adjusting the scale factor of the mono-channel signal that shaping the scale factor of the mono-channel signal is actually a process of scaling up a larger scale factor and removing a smaller scale factor. A large scale factor is scaled up, to effectively retain medium-frequency and high-frequency signals, and a smaller scale factor is removed, to delete a signal that is not easily perceived by the human ear. This can reduce a number of quantized bits, and reduce a bit rate. Therefore, in the adjustment manner, more information about a medium frequency and a high frequency can be retained, and compression efficiency of encoding an audio signal is improved while sound quality is ensured.

When the audio signal is a dual-channel signal, the scale factor of the sub-band may be adjusted based on the difference and a principle of maintaining a spectral shape of the audio signal and scaling down a spectrum as a whole, to obtain the adjustment factor. In this case, as shown in FIG. 8, an implementation process of operation 3042 includes the following operations.

Operation a1: Scale down the difference, to obtain a scaled-down difference.

In an embodiment, a scale-down multiple of the difference may be determined based on a value of the difference. When a strength of the audio signal is greater than the reference value, the human ear is more sensitive to the audio signal. When the strength of the audio signal is less than or equal to the reference value, the human ear is less sensitive to the audio signal. In this case, when the difference indicates that the scale factor of the sub-band is greater than the reference value, the scale-down multiple of the difference may be less than a scale-down multiple obtained when the difference indicates that the scale factor of the sub-band is less than or equal to the reference value. In addition, a value of the scale-down multiple may be determined based on the requirement on sound quality. For example, when the difference indicates that the scale factor of the sub-band is greater than the reference value, the scale-down multiple may be 0.375. When the difference indicates that the scale factor of the sub-band is less than or equal to the reference value, the scale-down multiple may be 0.5.

Operation a2: Update the scale factor of the sub-band based on the scaled-down difference and the reference value.

In an embodiment, the scaled-down difference may be added to the reference value, to obtain an updated scale factor of the sub-band. When the scale factor of the sub-band is masked, an updated scale factor E_{z}(b) of the b^{th} sub-band, the masked scale factor E_{new}(b) of the sub-band, and the reference value E_{avg} meet the following formula:

$${E}_{z} ( b ) = \{ \begin{matrix}{E}_{avg} + 0.375 \times ( {E}_{new} ( b ) - {E}_{avg} ) , {E}_{new} ( b ) > {E}_{avg} \\ {E}_{avg} + 0.5 \times ( {E}_{new} ( b ) - {E}_{avg} ) , {E}_{new} ( b ) \leq {E}_{avg}\end{matrix}$$

Operation a3: Obtain the adjustment factor based on the updated scale factor of the sub-band.

After the scale factor of the sub-band is updated based on the scaled-down difference and the reference value, the adjustment factor of the sub-band may be determined based on the updated scale factor of the sub-band and the original scale factor of the sub-band. In an embodiment, a difference value between the original scale factor of the sub-band and the updated scale factor of the sub-band may be determined as the adjustment factor of the sub-band. For example, the original scale factor E(b), the updated scale factor E_{z}(b), and the adjustment factor dr_{adjust}(b) of the b^{th} sub-band meet the following formula:

$${dr}_{adjust} ( b ) = E ( b ) - {E}_{z} ( b )$$

It can be learned from a process of adjusting the scale factor of the dual-channel signal that shaping the scale factor of the dual-channel signal is actually a process of maintaining the spectral shape of the audio signal and scaling down the spectrum as a whole. The dual-channel signal includes a left-channel signal and a right-channel signal, and signals of the two channels have an energy difference. The spectrum shape of the audio signal is maintained and the spectrum is scaled down as a whole, to effectively reduce loss of medium-frequency and high-frequency signals, and remove a signal that is not easily perceived by the human ear. This can reduce a number of quantized bits, and reduce a bit rate. Therefore, in the adjustment manner, more information about a medium frequency and a high frequency can be retained, and compression efficiency of encoding an audio signal is improved while sound quality is ensured. In addition, when the energy difference between the signals of the two channels in the dual-channel signal is large, this function is particularly obvious.

In conclusion, in the audio signal processing method provided in embodiments of this application, after the plurality of sub-bands of the audio signal and the scale factor of each sub-band are obtained, the reference value used for shaping the spectral envelope of the audio signal may be determined based on the scale factors of the plurality of sub-bands, and the spectral envelope of the audio signal is shaped by using the reference value as the baseline, to obtain the adjustment factor of each sub-band corresponding to the shaped spectral envelope. The adjustment factor is used to quantize the spectral value of the audio signal. Therefore, in the method, when the spectral envelope of the audio signal is shaped based on the reference value, and the adjustment factor obtained through shaping is used to quantize the spectral value of the audio signal, compression efficiency of encoding the audio signal can be improved while sound quality is ensured.

It should be noted that, a sequence of operations of the method provided in embodiments of this application may be appropriately adjusted, and an operation may be added or removed based on a situation. Any method variation readily figured out by one of ordinary skilled in the art within the technical scope disclosed in this application shall fall within the protection scope of this application. Therefore, details are not described.

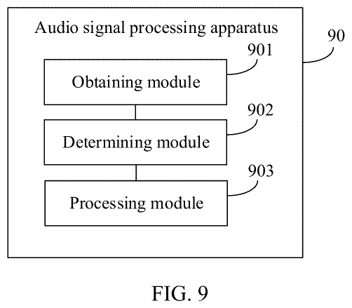

This application provides an audio signal processing apparatus. As shown in FIG. 9, an audio signal processing apparatus 90 includes:
an obtaining module 901, configured to obtain a plurality of sub-bands of an audio signal and a scale factor of each sub-band;
a determining module 902, configured to determine, based on the scale factors of the plurality of sub-bands, a reference value used for shaping a spectral envelope of the audio signal; and
a processing module 903, configured to shape the spectral envelope of the audio signal by using the reference value as a baseline, to obtain an adjustment factor of each sub-band corresponding to a shaped spectral envelope, where the adjustment factor is used to quantize a spectral value of the audio signal, and/or the adjustment factor is used to dequantize a code value of the spectral value.

In an embodiment, the processing module 903 is configured to: obtain a difference between the scale factor of the sub-band and the reference value; and adjust the scale factor of the sub-band based on the difference, to obtain the adjustment factor.

In an embodiment, the processing module 903 is further configured to mask the scale factor of the sub-band, and update the scale factor of the sub-band based on the masked scale factor of the sub-band.

In an embodiment, when the audio signal is a dual-channel signal, the processing module 903 is configured to: scale down the difference, to obtain a scaled-down difference; update the scale factor of the sub-band based on the scaled-down difference and the reference value; and obtain the adjustment factor based on an updated scale factor of the sub-band.

In an embodiment, a scale-down multiple of the difference is determined based on a value of the difference.

In an embodiment, when the audio signal is a mono-channel signal, the processing module 903 is configured to determine the difference as the adjustment factor.

In an embodiment, the processing module 903 is further configured to perform signal enhancement on the scale factor of the sub-band, and update the scale factor of the sub-band based on a scale factor that is of the sub-band and on which signal enhancement has been performed.

In an embodiment, when the audio signal is a dual-channel signal, the reference value is obtained based on an average value of the scale factors of the plurality of sub-bands.

When the audio signal is a mono-channel signal, the reference value is obtained based on a maximum value in the scale factors of the plurality of sub-bands.

In an embodiment, the processing module 903 is further configured to mask the scale factor of the sub-band, and update the scale factor of the sub-band based on the masked scale factor of the sub-band.

In an embodiment, when the audio signal is a mono-channel signal, the processing module 903 is further configured to perform signal enhancement on the scale factor of the sub-band, and update the scale factor of the sub-band based on a scale factor that is of the sub-band and on which signal enhancement has been performed.

In an embodiment, a strength of performing signal enhancement on the scale factor of the sub-band is determined based on a frequency of the sub-band and a total number of the plurality of sub-bands.

In an embodiment, the processing module 903 is configured to: obtain a masking coefficient that an adjacent sub-band of the sub-band has on the sub-band and a scale factor of the adjacent sub-band, where the masking coefficient indicates a masking degree; and obtain the masked scale factor of the sub-band based on the scale factor of the sub-band, the scale factor of the adjacent sub-band, and the masking coefficient that the adjacent sub-band has on the sub-band.

In an embodiment, when the audio signal is a dual-channel signal, the masking coefficient is determined based on a value relationship between the scale factor of the sub-band and the reference value.

When the audio signal is a mono-channel signal, the masking coefficient is determined based on a frequency relationship between the sub-band and the adjacent sub-band.

In an embodiment, the processing module 903 is configured to: when a bit rate of the audio signal is less than a bit rate threshold and/or an energy concentration of the audio signal is less than a concentration threshold, shape the spectral envelope of the audio signal by using the reference value as the baseline, to obtain the adjustment factor of each sub-band corresponding to the shaped spectral envelope.

In conclusion, in the audio signal processing apparatus provided in embodiments of this application, after the plurality of sub-bands of the audio signal and the scale factor of each sub-band are obtained, the reference value used for shaping the spectral envelope of the audio signal may be determined based on the scale factors of the plurality of sub-bands, and the spectral envelope of the audio signal is shaped by using the reference value as the baseline, to obtain the adjustment factor of each sub-band corresponding to the shaped spectral envelope. The adjustment factor is used to quantize the spectral value of the audio signal. Therefore, in the apparatus, when the spectral envelope of the audio signal is shaped based on the reference value, and the adjustment factor obtained through shaping is used to quantize the spectral value of the audio signal, compression efficiency of encoding the audio signal can be improved while sound quality is ensured.

It can be clearly understood by one of ordinary skilled in the art that, for the purpose of convenient and brief description, for detailed working processes of the foregoing apparatuses and modules, refer to corresponding content in the foregoing method embodiment. Details are not described herein again.

An embodiment of this application provides a computer device. The computer device includes a memory and a processor. The memory stores program instructions, and the processor runs the program instructions to perform the method provided in embodiments of this application. For example, the following processes are performed: obtaining a plurality of sub-bands of an audio signal and a scale factor of each sub-band; determining, based on the scale factors of the plurality of sub-bands, a reference value used for shaping a spectral envelope of the audio signal; and shaping the spectral envelope of the audio signal by using the reference value as a baseline, to obtain an adjustment factor of each sub-band corresponding to a shaped spectral envelope. The adjustment factor is used to quantize a spectral value of the audio signal, and/or the adjustment factor is used to dequantize a code value of the spectral value. In addition, for an implementation process in which the computer device executes the program instructions in the memory to perform operations of the method provided in embodiments of this application, refer to corresponding descriptions in the foregoing method embodiment. In an embodiment, FIG. 4 is a diagram of a structure of a computer device according to an embodiment of this application.

An embodiment of this application further provides a computer-readable storage medium. The computer-readable storage medium is a non-volatile computer-readable storage medium, and includes program instructions. When the program instructions are run on a computer device, the computer device is enabled to perform the method provided in embodiments of this application.

An embodiment of this application further provides a computer program product including instructions. When the computer program product runs on a computer, the computer is enabled to perform the method provided in embodiments of this application.

It should be understood that “at least one” mentioned in this specification refers to one or more, and “a plurality of” refers to two or more. In the descriptions of embodiments of this application, unless otherwise specified, “/” means “or”. For example, A/B may represent A or B. In this specification, “and/or” describes only an association relationship between associated objects and represents that three relationships may exist. For example, A and/or B may represent the following three cases: Only A exists, both A and B exist, and only B exists. In addition, to clearly describe the technical solutions in embodiments of this application, terms such as “first” and “second” are used in embodiments of this application to distinguish between same items or similar items that have basically same functions and purposes. One or ordinary skilled in the art may understand that the terms such as “first” and “second” do not limit a number or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of this application are used under authorization by the user or full authorization by all parties, and capturing, use, and processing of related data need to conform to related laws, regulations, and standards of related countries and regions. For example, the audio signal related in embodiments of this application is obtained under full authorization.

The foregoing descriptions are embodiments provided in this application, but are not intended to limit this application. Any modification, equivalent replacement, or improvement made without departing from the spirit and principle of this application shall fall within the protection scope of this application.

What is claimed is:

1. An audio signal processing method, comprising:
obtaining a plurality of sub-bands of an audio signal and a scale factor of each sub-band;
determining, based on scale factors of the plurality of sub-bands, a reference value used for shaping a spectral envelope of the audio signal; and
shaping the spectral envelope of the audio signal by using the reference value as a baseline, to obtain an adjustment factor of each sub-band corresponding to a shaped spectral envelope, wherein the adjustment factor is used to quantize a spectral value of the audio signal, and/or the adjustment factor is used to dequantize a code value of the spectral value.

2. The method according to claim 1, wherein the shaping the spectral envelope of the audio signal by using the reference value as a baseline, to obtain the adjustment factor of each sub-band corresponding to the shaped spectral envelope comprises:
obtaining a difference between the scale factor of the sub-band and the reference value; and
adjusting the scale factor of the sub-band based on the difference, to obtain the adjustment factor.

3. The method according to claim 2, wherein before the shaping the spectral envelope of the audio signal by using the reference value as the baseline, to obtain the adjustment factor of each sub-band corresponding to the shaped spectral envelope, the method further comprises:
masking the scale factor of the sub-band, and updating the scale factor of the sub-band based on a masked scale factor of the sub-band.

4. The method according to claim 2, wherein when the audio signal is a dual-channel signal, the adjusting the scale factor of the sub-band based on the difference, to obtain the adjustment factor comprises:
scaling down the difference, to obtain a scaled-down difference;
updating the scale factor of the sub-band based on the scaled-down difference and the reference value; and
obtaining the adjustment factor based on an updated scale factor of the sub-band.

5. The method according to claim 4, wherein a scale-down multiple of the difference is determined based on a value of the difference.

6. The method according to claim 2, wherein when the audio signal is a mono-channel signal, the adjusting the scale factor of the sub-band based on the difference, to obtain the adjustment factor comprises:
determining the difference as the adjustment factor.

7. The method according to claim 6, wherein before the obtaining the difference between the scale factor of the sub-band and the reference value, the method further comprises:
performing signal enhancement on the scale factor of the sub-band, and updating the scale factor of the sub-band based on a scale factor of the sub-band and on which signal enhancement has been performed.

8. The method according to claim 1, wherein
when the audio signal is a dual-channel signal, the reference value is obtained based on an average value of the scale factors of the plurality of sub-bands; and
when the audio signal is a mono-channel signal, the reference value is obtained based on a maximum value in the scale factors of the plurality of sub-bands.

9. The method according to claim 8, wherein before the determining the reference value used for shaping the spectral envelope of the audio signal, the method further comprises:
masking the scale factor of the sub-band, and updating the scale factor of the sub-band based on the masked scale factor of the sub-band.

10. The method according to claim 8, wherein when the audio signal is a mono-channel signal, before the determining the reference value used for shaping the spectral envelope of the audio signal, the method further comprises:
performing signal enhancement on the scale factor of the sub-band, and updating the scale factor of the sub-band based on a scale factor of the sub-band and on which signal enhancement has been performed.

11. The method according to claim 7, wherein a strength of performing signal enhancement on the scale factor of the sub-band is determined based on a frequency of the sub-band and a total number of the plurality of sub-bands.

12. The method according to claim 3, wherein the masking the scale factor of the sub-band comprises:
obtaining a masking coefficient that an adjacent sub-band of the sub-band has on the sub-band and a scale factor of the adjacent sub-band, wherein the masking coefficient indicates a masking degree; and
obtaining the masked scale factor of the sub-band based on the scale factor of the sub-band, the scale factor of the adjacent sub-band, and the masking coefficient that the adjacent sub-band has on the sub-band.

13. The method according to claim 12, wherein
when the audio signal is a dual-channel signal, the masking coefficient is determined based on a value relationship between the scale factor of the sub-band and the reference value; and
when the audio signal is a mono-channel signal, the masking coefficient is determined based on a frequency relationship between the sub-band and the adjacent sub-band.

14. The method according to claim 1, wherein the shaping the spectral envelope of the audio signal by using the reference value as the baseline, to obtain the adjustment factor of each sub-band corresponding to the shaped spectral envelope comprises:
when a bit rate of the audio signal is less than a bit rate threshold and/or an energy concentration of the audio signal is less than a concentration threshold, shaping the spectral envelope of the audio signal by using the reference value as the baseline, to obtain the adjustment factor of each sub-band corresponding to the shaped spectral envelope.

15. A computer device, comprising:
a processor, and
a memory, coupled to the processor to store instructions, which when executed by the processor, cause the processor to:
obtain a plurality of sub-bands of an audio signal and a scale factor of each sub-band;
determine, based on scale factors of the plurality of sub-bands, a reference value used for shaping a spectral envelope of the audio signal; and
shape the spectral envelope of the audio signal by using the reference value as a baseline, to obtain an adjustment factor of each sub-band corresponding to a shaped spectral envelope, wherein the adjustment factor is used to quantize a spectral value of the audio signal, and/or the adjustment factor is used to dequantize a code value of the spectral value.

16. The device according to claim 15, wherein the processor to shape the spectral envelope of the audio signal by using the reference value as the baseline comprises the processor to:
obtain a difference between the scale factor of the sub-band and the reference value; and
adjust the scale factor of the sub-band based on the difference, to obtain the adjustment factor.

17. The device according to claim 16, wherein when the instructions executed by the processor, further cause the processor to:
mask the scale factor of the sub-band, and update the scale factor of the sub-band based on a masked scale factor of the sub-band.

18. A non-transitory machine-readable storage medium having instructions stored therein, which when executed by a processor, causes the processor to perform operations, the operations comprising:
obtaining a plurality of sub-bands of an audio signal and a scale factor of each sub-band;
determining, based on scale factors of the plurality of sub-bands, a reference value used for shaping a spectral envelope of the audio signal; and
shaping the spectral envelope of the audio signal by using the reference value as a baseline, to obtain an adjustment factor of each sub-band corresponding to a shaped spectral envelope, wherein the adjustment factor is used to quantize a spectral value of the audio signal, and/or the adjustment factor is used to dequantize a code value of the spectral value.

19. The non-transitory machine-readable storage medium according to claim 18, wherein the shaping the spectral envelope of the audio signal by using the reference value as the baseline, to obtain the adjustment factor of each sub-band corresponding to the shaped spectral envelope comprises:
obtaining a difference between the scale factor of the sub-band and the reference value; and
adjusting the scale factor of the sub-band based on the difference, to obtain the adjustment factor.

20. The non-transitory machine-readable storage medium according to claim 18, wherein the shaping the spectral envelope of the audio signal by using the reference value as the baseline, to obtain the adjustment factor of each sub-band corresponding to the shaped spectral envelope comprises:
when a bit rate of the audio signal is less than a bit rate threshold and/or an energy concentration of the audio signal is less than a concentration threshold, shaping the spectral envelope of the audio signal by using the reference value as the baseline, to obtain the adjustment factor of each sub-band corresponding to the shaped spectral envelope.
